(19) United States
(12) Patent Application Publication
(10) Pub. No.: US 2007/0069974 A1
(43) Pub. Date: Mar. 29, 2007

(54) Multiple image display apparatus

(76) Inventors: Yasushi Kawata, Ageo-shi (JP); Akio Murayama, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/524,937

(22) Filed: Sep. 22, 2006

(30) Foreign Application Priority Data
Sep. 29, 2005 (JP) 2005-283542

(51) Int. Cl. G09G 5/00

(52) U.S. Cl. 345/1.1

(57) ABSTRACT

A multiple image display apparatus includes a back surface display apparatus arranged on a back surface side, a transmission type display device arranged to oppose a display region of the back surface display apparatus, and a light path control unit arranged between the back surface display apparatus and the display device and opposing the display region of the back surface display apparatus and the display device. The light path control unit is configured to optionally switch a transmission mode for transmitting light and a diffusion mode for diffusing light.

### CROSS-REFERENCE TO RELATED APPLICATIONS

This application is based upon and claims the benefit of priority from prior Japanese Patent Application No. 2005-283542, field Sep. 29, 2005, the entire contents of which are incorporated herein by reference.

### BACKGROUND OF THE INVENTION

1. Field of the Invention

The present invention relates to a multiple image display apparatus capable of displaying plural images on one screen by overlapping them.

2. Description of the Related Art

A display apparatus using a liquid crystal display device is applied to various fields such as OA equipment, information terminals, clocks, and TVs because it has the features of being light, thin, and power-saving. In particular, since a liquid crystal display device using thin film transistors (TFTs) has a high response property, it is used for a display of computers, mobile TVs, and the like for displaying data content.

Recently, higher resolution and faster response have come to be required in displayed images to cope with increasingly complete content. In addition, demand for game displays and in-car displays has increased for a see-through display device to display information on a transparent panel only when necessary.

The display device employs a coloring system and a spontaneous light emitting system such as electrochromism and electroluminescence or an optical switching system such as a liquid crystal display device. The former systems have not yet reached a practically usable level due to many problems of reliability, low transmittance, and the like.

Since the latter liquid crystal display device uses a polarization plate and a color filter, transmittance is reduced to about 1 to 10%. However, a peer-through type display apparatus, which is composed of plural display devices arranged in one hermetically sealed space, has sufficient visibility. There is proposed a multiple image display apparatus as a display for use in the amusement field such as at a pachinko parlor and the like. In the multiple image display apparatus, plural liquid crystal display devices are arranged in an overlapped fashion and plural images can be displayed in an overlapped fashion.

For example, in a multiple image display apparatus disclosed in Jpn. Pat. Appln. KOKAI Publication No. 2005-006961, plural liquid crystal display devices arranged in an overlapped fashion have independent light sources, respectively. Images being displayed are synthesized and separated by turning on and off the plural light sources, respectively.

However, when the light source is arranged to each of the display devices as in the above multiple image display apparatus, the structure is made complex as well as installation space and a manufacturing cost being increased. Further, when the plural light sources are turned on and off respectively, a whole image screen is switched, from which a problem arises in that the amount of information that can be intrinsically displayed by the multiple image display apparatus cannot be sufficiently displayed.

### BRIEF SUMMARY OF THE INVENTION

The present invention has been contrived in consideration of the above circumstances and its object is to provide a multiple image display apparatus that can easily synthesize and separate images and increase the amount of information which can be displayed.

In order to achieve the above object, a multiple image display apparatus according to an aspect of the present invention comprises: a back surface display apparatus arranged on a back surface side; a transmission type display device opposed to a display region of the back surface display apparatus; and a light path control unit arranged between the back surface display apparatus and the display device and opposed to the display region of the back surface display apparatus and the display device, the light path control unit being configured to arbitrarily control a transmission mode for transmitting light and a diffusion mode for diffusing light.

According to the above configuration, there can be provided a multiple image display apparatus that can display respective images to be displayed in a multiple fashion independently or in a mixed fashion at an arbitrary ratio and increase the amount of information which can be displayed.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view showing a multiple image display apparatus according to a first embodiment of the present invention;

FIG. 2 is a side elevational view of a housing of the multiple image display apparatus in a broken fashion;

FIG. 3 is a sectional view showing a back surface display apparatus in the multiple image display apparatus;

FIG. 4 is a sectional view showing a light path control unit in the multiple image display apparatus;

FIG. 5 is a sectional view showing the light path control unit in a transmission mode;

FIG. 6 is a block diagram showing a control system of the multiple image display apparatus;

FIG. 7 is a view showing a state in which only a back surface image is displayed in the multiple image display apparatus;

FIG. 8 is a view showing a state in which only the image of a front surface side display device are displayed in the multiple image display apparatus;

FIG. 9 is a view showing a state in which the back surface image and the front surface image are synthesized;

FIG. 10 is a view showing a state in which the back surface image and the image displayed by the display device are partially displayed;

FIG. 11 is a side elevational view showing a multiple image display apparatus according to a second embodiment of the present invention;

FIG. 12 is a view showing a state in which only a back surface image is displayed in the multiple image display apparatus according to the second embodiment;

FIG. 13 is a view showing a state in which only the image of a front surface side display device is displayed in the multiple image display apparatus according to the second embodiment;

FIG. 14 is a view showing a state in which a back surface image and a front surface image are synthesized and displayed in the multiple image display apparatus of the second embodiment;

FIG. 15 is a view showing a state in which the back surface image and the image displayed by the display device are partially displayed in the multiple image display apparatus according to the second embodiment;

FIG. 16 is a side elevational view showing a multiple image display apparatus according to a third embodiment of the present invention;

FIG. 17 is a view showing a state in which only a back surface image is displayed in the multiple image display apparatus according to the third embodiment;

FIG. 18 is a view showing a state in which the back surface image and a front surface image are synthesized and displayed in the multiple image display apparatus according to the third embodiment; and

FIG. 19 is a view showing a state in which only the image of a front surface side display device is displayed in the multiple image display apparatus according to the third embodiment.

### DETAILED DESCRIPTION OF THE INVENTION

A multiple image display apparatus according to a first embodiment of the present invention will be explained below in detail with reference to the drawings.

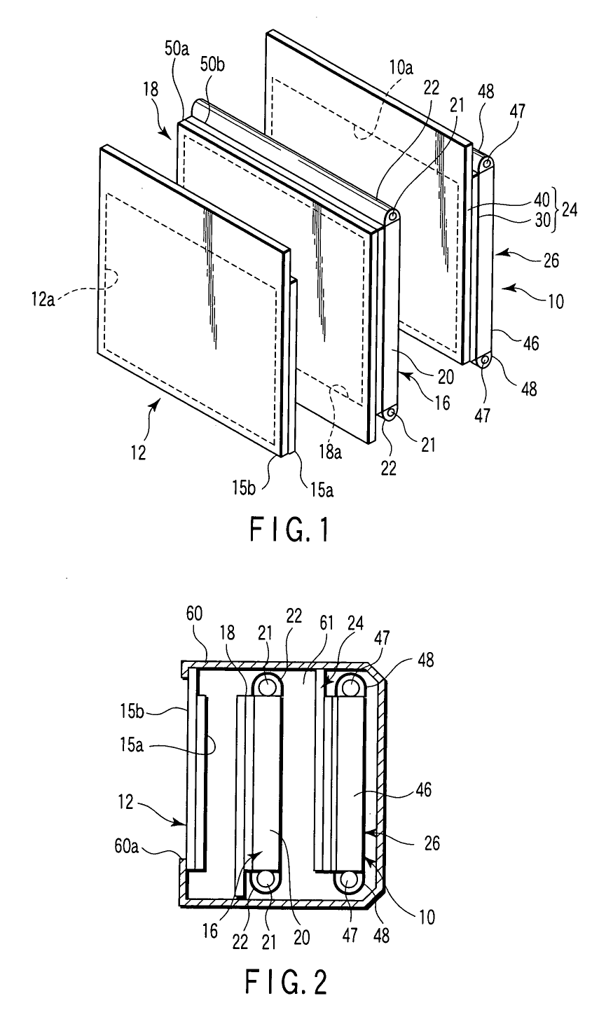

FIGS. 1 and 2 show an overall configuration of the multiple image display apparatus by exploding it. As shown in FIGS. 1 and 2, the multiple image display apparatus includes a back surface display apparatus 10 arranged nearest to a back surface side, and a transmission type display device 12 arranged on the front surface side of the back surface display apparatus 10 to oppose a display region 10a of the back surface display apparatus 10. A transparent backlight 16 acting as a light source of the display device 12 and a light path control unit 18 are arranged between the back surface display apparatus 10 and the display device 12 and opposite to the display region 10a of the back surface display apparatus 10 and the display device 12. The light path control unit 18 is configured to optionally switch a transmission mode for transmitting light and a diffusion mode for diffusing light.

The back surface display apparatus 10 has a liquid crystal display device 24 as a display device and a backlight 26 for illuminating the liquid crystal display device 24. As shown in FIGS. 1 to 3, the liquid crystal display device 24 is configured as an active matrix type liquid crystal display device. The liquid crystal display device 24 includes an array substrate 30 having a coloring layer as a color filter formed thereon and an opposite substrate 40 arranged opposing to the array substrate with a predetermined cell gap. A liquid crystal layer 32 is sealed between the array substrate 30 and the opposite substrate 40. The peripheral edge portion of the array substrate 30 is joined to the peripheral edge portion of the opposite substrate 40 by a seal member 33 arranged so as to surround the outer periphery of the display region 10a.

The opposite substrate 40 is configured by sequentially forming a transparent electrode 42 formed of ITO and an orientation film 43 on a transparent substrate 41 composed of glass.

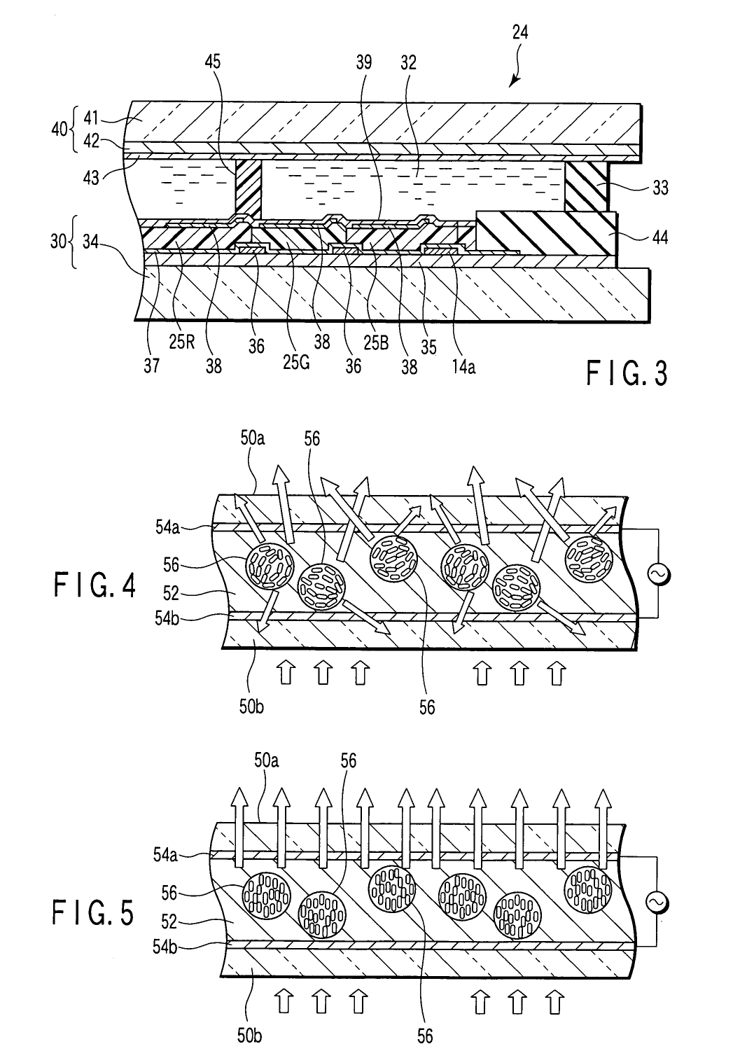

As shown in FIG. 3, the array substrate 30 has a transparent substrate 34 composed of glass, and plural scanning lines (not shown), plural signal lines 36 extending in a direction perpendicular to the scanning lines with interposing an insulation film 35, switching elements (TFTs) (not shown) connected to the vicinities of the respective corossing regions of the scanning lines and the signal lines, and the like are arranged on the transparent substrate 34. A liquid crystal drive circuit (not shown) is formed outside of the display region 10a on the transparent substrate 34.

A protective insulation film 37 is arranged to cover the switching elements and the liquid crystal drive circuit, and further green (G) colored layers 25G, blue (B) colored layers 25B, and red (R) colored layers 25R each extending in a Y-direction and formed in a stripe shape are arranged on the protective insulation film 37. Many pixel electrodes 38 are provided on the colored layers 25G, 25B, and 25R in a matrix manner. The respective pixel electrodes 38 are connected to source electrodes of corresponding switching elements through contact holes formed in the colored layers 25G, 25B, and 25R and the protective insulation film 37, and through upper electrodes (not shown), respectively. An orientation film 39 is formed on the entire surface of the transparent substrate 34 so as to cover the pixel electrodes 38 and the colored layers 25G, 25B, and 25R.

A rectangular frame pattern 44, which is composed of a black colored layer having a predetermined width, is formed on the transparent substrate 34 of the array substrate 30 so as to surround the peripheral edge of the display region 10a. The frame pattern 44 is formed thicker than the other colored layers 25G, 25B, and 25R. Many columnar spacers 45 are formed on the pixel electrodes 38 at a desired density simultaneously with the frame pattern 44. The seal member 33 is arranged on the frame pattern 44 around the peripheral edge of the display region 10a.

The peripheral edge portion of the array substrate 30 is bonded to the peripheral edge portion of the opposite substrate 40 through the seal member 33 as well as the cell gap between the substrates is kept to a predetermined value by the many columnar spacers 45.

As shown in FIG. 1, the backlight 26 of the back surface display apparatus 10 includes, for example, a transparent rectangular light guide plate 46, linear light sources 47 arranged opposing the respective side edges of the light guide plate, reflectors 48 covering the respective light sources, an optical sheet (not shown) formed on the light guide plate, and the like.

The light guide plate 46 is arranged to oppose the back surface side of the liquid crystal display device 24, here, oppose the array substrate 30 adjacent to it. The light guide plate 46 irradiates the light emitted from the light sources 47 to the entire surface of the liquid crystal display device 24.

As shown in FIGS. 1 and 2, the display device 12 is configured as a transmission type liquid crystal display device. The display device 12 includes an array substrate 15a and an opposite substrate 15b arranged to oppose each other and a liquid crystal layer (not shown) sealed between these substrates. Another configurations of the display device 12 is same as those of the liquid crystal display device 24 of the back surface display apparatus 10.

A polymer-dispersion liquid crystal (PDLC) device and a liquid crystal device having a mode of polymer stabilized cholesteric texture (PSCT) and the like can be used as the light path control unit 18. However, any device may be basically used as the light path control unit 18 as long as it can arbitrarily control two states, that is, a transparent state and an opaque state in which light is dispersed and diffused, in response to a signal applied from the outside in addition to the above devices.

As shown in FIG. 4, according to the embodiment, the light path control unit 18 is configured as the polymer-dispersion liquid crystal (PDLC) device. That is, the light path control unit 18 includes two transparent substrates 50a and 50b opposing to each other with a gap, and a nematic liquid crystal polymer layer 52 polymerized by bridging, for example, a nematic liquid crystal is interposed between the substrates.

Electrodes 54a and 54b are arranged on both the sides of the nematic liquid crystal polymer layer 52 to apply an electric field to them. The electrodes 54a and 54b are arranged on the inner surfaces of the substrates 50a and 50b in parallel with each other. The electrodes 54a and 54b are supplied with a voltage from a power supply 74 to be described later and apply an electric field in a direction approximately perpendicular to the longitudinal-axis direction of liquid crystal molecules.

Nematic liquid crystal droplets 56, which are not bridged, that is, which are not polymer, are disposed in the nematic liquid crystal polymer layer 52. As shown in FIG. 4, in a state in which no electric field is applied, the liquid crystal molecules of the nematic liquid crystal droplets 56 are arranged along the interface of the droplets and set to the diffusion mode for diffusing light. When the electric field is applied to the nematic liquid crystal polymer layer 52, the liquid crystal molecules of the nematic liquid crystal droplets 56 are arranged such that the longitudinal axes of them are aligned in the direction of the electric field, here, in a direction pependicular to the substrates 50a and 50b as shown in FIG. 5. With this arrangement, the nematic liquid crystal polymer layer 52 can transmit light, and thus the transmission mode is set.

When the liquid crystal device of the PDLC, the PSCT, or the like is used, it is preferable to use a transparent conductive film of ITO, IZO, or the like as the material of the electrodes 54a and 54b for applying the electric field to the liquid crystal layer to improve the light transmission of the liquid crystal device in a transparent state, that is, in the transmission mode. Even when an electrode flatly arranged on the entire surface of the liquid crystal device is composed of the transparent conductive film, the nematic liquid crystal polymer layer 52 can be controlled to a light transmission state and a light dispersing state.

Further, when the amount of information to be displayed is increased by setting the entire surface of an effective region 18a of the light path control unit 18 or setting partially a desired region in the effective region 18a to the transmission mode or the diffusion mode, it is preferable to use a segment type electrode structure or a simple matrix type stripe electrode structure formed of the transparent conductive film.

In particular, when the transmission and the diffusion of an arbitrary region is controlled by the simple matrix type stripe electrode structure, it is preferable to employ a liquid crystal mode showing hysteresis as a voltage-transmittance characteristic. More preferably, it is possible to simultaneously realize reduction of power consumption and the like by using a liquid crystal mode having a memory property of a phase transfer type PSCT.

The light path control unit 18 is arranged to the back surface side of the display device 12 and opposes the effective region 12a of the display device 12. When the display device 12 is formed of a liquid crystal display device, the light path control unit 18 is interposed between the transparent backlight 16 and the display device 12. When the light path control unit 18 is arranged on the back surface side of the backlight 16, the light path control unit 18 can act as a backlight diffusion sheet used in an ordinary liquid crystal display apparatus.

The backlight 16 is interposed between the display device 12 and the light path control unit 18 or between the light path control unit 18 and the back surface display apparatus 10. In the embodiment, the backlight 16 is arranged between the light path control unit 18 and the back surface display apparatus 10 and opposite to the back surface of the light path control unit. The backlight 16 includes, for example, a transparent rectangular light guide plate 20, linear light sources 21 arranged to oppose both side edges of the light guide plate, reflectors 22 covering the respective light sources, an optical sheet (not shown) formed on the light guide plate, and the like. The light guide plate 20 is formed of a transparent acrylic plate. A white light source such as a cold cathode ray tube, or an LED is used as the light sources 21. The light guide plate 20 irradiates the light emitted from the light sources 21 to the overall surfaces of the light path control unit 18 and the display device 12.

As shown in FIG. 2, the multiple image display apparatus includes a housing 60 for defining a hermetically sealed space 61. The back surface display apparatus 10, the backlight 16, the light path control unit 18, and the display device 12 are housed in the hermetically sealed space 61. However, the effective region 12a of the display device 12 arranged on the most front surface side is exposed to the outside through a window portion 60a formed in the housing 60.

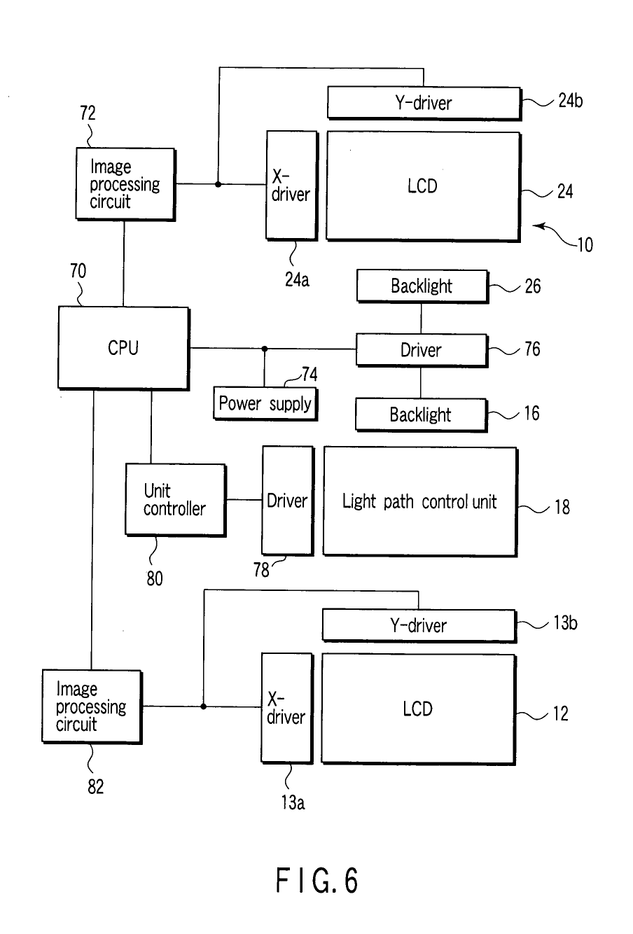

FIG. 6 shows a control system of the multiple image display apparatus. The control system includes a CPU 70 for controlling the operation of the whole apparatus, an image processing circuit 72 which supplies scan signals and video signals to an X-driver 24a and a Y-driver 24b provided at the liquid crystal display device 24 of the back surface display apparatus 10, the power supply 74, and a driver 76 for driving the backlights 26 and 16 of the back surface display apparatus 10, respectively. Further, the control system includes a driver 78 for applying a voltage to the electrodes 54a and 54b of the light path control unit 18, a unit controller 80 for controlling the modes of the light path control unit 18, and an image processing circuit 82 for supplying a scan signal and a video signal to an X-driver 13a and a Y-driver 13b provided at the display device 12, respectively.

A display operation of the multiple image display apparatus configured as described above will be explained.

FIG. 7 shows a display screen when only a back surface image of the back surface display apparatus 10 is displayed. In this case, for example, speed information, travel information, and the like of an automobile, are displayed on the liquid crystal display device 24 of the back surface display apparatus 10, the backlight 26 is turned on, and the light path control unit 18 arranged in the intermediate portion is set to the transmission mode. Further, the display device 12 is also set to a transparent state. The transparent backlight 16 may be set to any of on and off.

FIG. 8 shows a display screen when an image, for example, a map is displayed only on the display device 12 arranged on the front surface. In this case, the light path control unit 18 is set to the diffusion mode, and the transparent backlight 16 is turned ON. With this arrangement, the light path control unit 18 and the backlight 26 illuminate the display device 12 together from the back surface side, so that an image is displayed. The liquid crystal display device 24 and the backlight 26 of the back surface display apparatus 10 may be set to any of on and off.

FIG. 9 shows a display screen on which an image displayed by the back surface display apparatus 10 and an image displayed by the display device 12 overlap at an arbitrary ratio. In this case, the liquid crystal display device 24 and the backlight 26 are set to an ON state, acts as ordinary display devices, and display, for example, a map. The light path control unit 18 arranged in the intermediate portion is controlled in a dispersing state according to the mixing ratio of the image displayed by the back surface display apparatus 10 and the image displayed by the display device 12 by controlling a voltage applied to the electrode by the unit controller 80. When the light path control unit 18 is set to a completely transparent transmission mode, the image of the liquid crystal display device 24 and the image of the front surface display device 12 are made to a mixed image of 1:1.

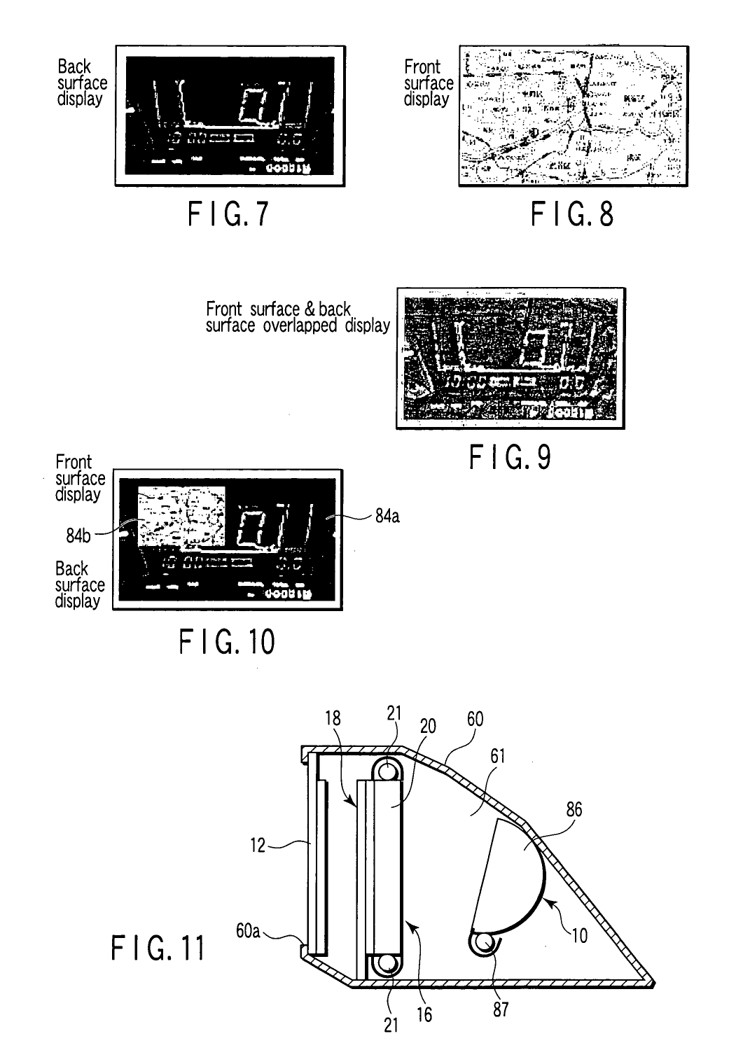

FIG. 10 shows a display screen on which the image displayed by the back surface display apparatus 10 and the image displayed by the display device 12 are partially displayed. In this case, a region 84a of the light path control unit 18 for displaying the image displayed by the back surface display apparatus 10 is set to the transmission mode, and a region 84b of it for displaying the image displayed by the display device 12 is set to the diffusion mode. It is also possible to partially display the image of the back surface display apparatus 10 and the image of the display device 12 by mixture by changing the intensity of dispersion of the light path control unit 18.

According to the multiple image display apparatus configured as described above, the respective images to be displayed in a multiple fashion can be displayed independently or displayed in a mixed fashion at an arbitrary ratio. As a result, the amount of information to be displayed can be increased. At least one light path control unit, which can arbitrarily control the two states of transmission and diffusion, is arranged between at least two display apparatuses or between display devices. Accordingly, images can be synthesized or separated on the entire surface of a display region or in an arbitrary region by controlling the light path control unit without the need of turning on and off the respective light sources for illuminating the display device and the display apparatus. Thus, there can be provided a multiple image display apparatus in which the amount of information to be displayed is increased.

Next, a multiple image display apparatus according to a second embodiment of the present invention will be explained. FIG. 11 shows the second embodiment in which the multiple image display apparatus is applied to an instrument panel of an automobile. An automobile meter 86 including a speed meter, a tachometer, and the like is arranged to the instrument panel. A side surface light source 87 is arranged under the meter 86 to illuminate the meters. The meter 86 and the side surface light source 87 constitute a back surface display apparatus 10.

A display device 12 is arranged on the front surface side of the meter 86 in confrontation with the meter 86 to display map information and the like. The display device 12 is composed of a transmission type liquid crystal display device. A transparent backlight 16 acting as a light source is arranged on the back surface side of the display device 12, that is, between the display device 12 and the meter 86. A light path control unit 18, which can arbitrarily switch a transmission mode and a diffusion mode, is interposed between the backlight 16 and the display device 12 and confronts with the display device 12 and the backlight 16.

The display device 12 and the backlight 16 have the same configurations as those of the first embodiment. A polymer-dispersion liquid crystal (PDLC) is used as the light path control unit 18. In this case, a PDLC device is configured by preparing a solution in which a reactive acrylic monomer material acting as a polymer precursor is mixed with a reactive acrylic oligomer material, preparing a mixed solution by mixing 20% of the solution with 80% of a liquid crystal material, and spontaneously inducing the phase separation structure of liquid crystal/polymer by irradiating UV light to the mixed solution. The other configuration of the light path control unit 18 is the same as that of the first embodiment described above.

All the components are arranged in a hermetically sealed space 61 defined by a housing 60 constituting the instrument panel. A display region 12a of the display device 12 is exposed to a window portion 60a formed to the housing 60. With this arrangement, an image of the display device 12 and an image of the meter 86 can be synthesized while keeping high contrast without being affected by external light.

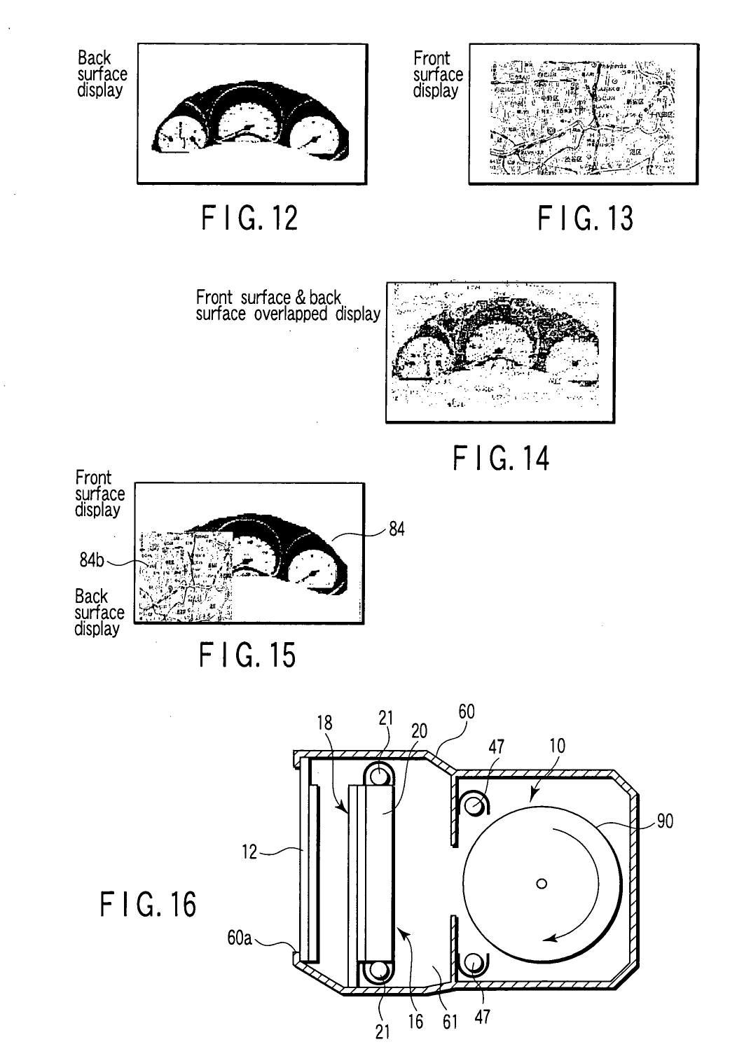

FIG. 12 shows a display screen when only an image of the meter 86 on the back surface side is displayed. In this case, the backlight 87 is turned ON, and the light path control unit 18 arranged in the intermediate portion is set to the transmission mode. The display device 12 is set to a transparent state. The transparent backlight 16 may be set to any of on and off.

FIG. 13 shows a display screen when an image, for example, a map is displayed only on the display device 12 arranged on a front surface. In this case, the light path control unit 18 is set to the diffusion mode, and the backlight 16 is turned ON. With this arrangement, the light path control unit 18 and the backlight 16 illuminate the display device 12 together from the back surface side of it, so that an image is displayed. The backlight 87 of the back surface display apparatus 10 may be any of on and off.

FIG. 14 shows a display screen on which an image displayed by the meter 86 and an image displayed by the display device 12 overlap at an arbitrary ratio. In this case, the backlight 87 is set an on state, and the light path control unit 18 arranged in the intermediate portion is controlled in a dispersing state according to the mixing ratio of the image displayed by the back surface display apparatus 10 and the image displayed by the display device 12 by controlling a voltage applied to an electrode by the unit controller 80.

FIG. 15 shows a display screen in which a map is partially displayed by the display device 12 on a part of the front surface of the meter 86 on the back surface. In this case, a region 84a of the light path control unit 18 for displaying an image displayed by meter 86 is set to the transmission mode, and a region 84b of the light path control unit 18 for displaying an image displayed by the display device 12 is set to the diffusion mode.

Next, a multiple image display apparatus according to a third embodiment of the present invention will be explained. FIG. 16 shows the third embodiment in which the multiple image display apparatus is applied to a display unit of a slot machine.

The display unit has a cylindrical reel 90 arranged rotatably, and a light source 47 for illuminating the outer peripheral surface of the reel. Many symbols are shown on the outer peripheral surface of the reel 90 constituting a support member side by side in a peripheral direction and an axial direction. The reel 90 and the light source 47 constitute a back surface display apparatus 10. The reel 90 is rotated by a drive system (not shown).

A display device 12 is arranged on the front surface side of the reel 90 in confrontation with it. The display device 12 is composed of a transmission type liquid crystal display device. A transparent backlight 16 acting as a light source is arranged on the back surface side of the display device 12, that is, between the display device 12 and the reel 90. A light path control unit 18, which can arbitrarily switch a transmission mode and a diffusion mode, is interposed between the backlight 16 and the display device 12 in confrontation with them.

The display device 12 and the backlight 16 have the same configurations as those of the first embodiment described above. A polymer stabilized cholesteric texture (PSCT), which is excellent in a memory property, is used as the light path control unit 18. The other configuration of the light path control unit 18 is the same as that of the first embodiment described above.

All the components described above are arranged in a hermetically sealed space 61 defined by a housing 60 of the slot machine. With this arrangement, independent and synthesized images with high contrast can be obtained without being affected by external light.

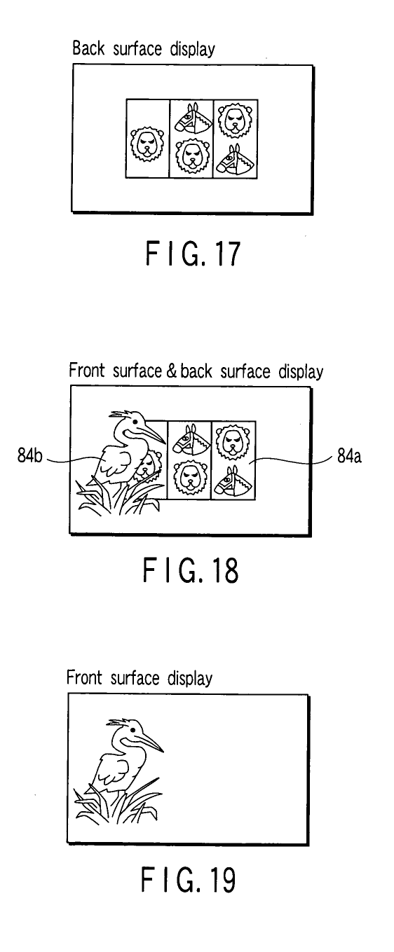

FIG. 17 shows a display screen on which only images of the reel 90 on a back surface side are displayed. In this case, the backlight 47 is turned on, and the light path control unit 18 arranged in the intermediate portion is set to the transmission mode. The display device 12 is set to a transparent state. The transparent backlight 16 may be set to any of on and off.

FIG. 18 shows a display screen on which images of the reel 90 of the back surface and an image of the display device 12 are synthesized. In this case, a region 84a of the light path control unit 18 for displaying the images displayed by the reel 90 is set to the transmission mode, and a region 84b of the light path control unit 18 for displaying the image displayed by the display device 12 is set to the diffusion mode.

FIG. 19 shows a display screen when an image is displayed only on the display device 12 arranged on a front surface. In this case, the light path control unit 18 is set to the diffusion mode, and the backlight 16 is turned on. With this arrangement, the light path control unit 18 and the backlight 16 illuminate the display device 12 together from the back surface side of it, so that an image is displayed as well as a white back image screen is displayed.

According to the second and third embodiments arranged as described above, the same operation effect as the first embodiment described above can be obtained. In a conventional arrangement using only a transparent backlight, an image of the display device 12 can be independently displayed only when a light source of a back surface display apparatus is turned off. However, in this case, since a back surface is inevitably displayed in black, it is difficult to obtain a sufficient display performance intrinsically provided with the multiple image display apparatus.

In contrast, according to the multiple image display apparatus of the embodiment, the light path control unit 18 arranged on the front surface (or back surface) of the transparent backlight 16 permits the display device 12 to use bright dispersed light as backlight. Accordingly, even if the display device 12 is independently displayed, a white back surface can be used, and thus an amount of information more than twice a conventional amount of information can be displayed.

The present invention is not limited directly to the embodiments described above, and its components may be embodied in modified forms without departing from the spirit of the invention. Further, various inventions may be made by suitably combining a plurality of components described in connection with the foregoing embodiments. For example, some of the components according to the foregoing embodiments may be omitted. Furthermore, components according to different embodiments may be combined as required.

In the embodiments described above, although the transparent backlight is interposed between the light path control unit and the back surface display apparatus, it may be interposed between the light path control unit and the display device on the front surface side.

What is claimed is:

1. A multiple image display apparatus comprising:
a back surface display apparatus arranged on a back surface side;
a transmission type display device opposed to a display region of the back surface display apparatus; and
a light path control unit arranged between the back surface display apparatus and the display device and opposed to the display region of the back surface display apparatus and the display device, the light path control unit being configured to arbitrarily control a transmission mode for transmitting light and a diffusion mode for diffusing light.

2. The multiple image display apparatus according to claim 1, which further comprises a transparent backlight which illuminates the display device and is arranged between the display device and the back surface display apparatus,
wherein the light path control unit is arranged between the display device and the backlight, or between the backlight and the back surface display apparatus.

3. The multiple image display apparatus according to claim 1, wherein the display device has a transmission type liquid crystal display device.

4. The multiple image display apparatus according to claim 1, wherein the light path control unit has an effective region opposing the display device and includes a control unit which selectively controls the transmission mode and the diffusion mode in the entire effective region and in an arbitrary region of a part of the effective region.

5. The multiple image display apparatus according to claim 4, wherein the control unit controls the transmission mode and the diffusion mode of the light path control unit and displays an image displayed by the back surface display apparatus and an image displayed by the display device as independent images or as an overlapped composite image.

6. The multiple image display apparatus according to claim 1, wherein the light path control unit has a pair of transparent substrates arranged opposing each other, a polymer dispersing type liquid crystal arranged between the substrates, and an electrode which applies a voltage to the polymer dispersing type liquid crystal.

7. The multiple image display apparatus according to claim 1, which further comprises a housing defining a hermetically sealed space in which the back surface display apparatus, the light path control unit, and the display device are housed, and the housing has a window portion from which the display region of the display device is exposed.

8. The multiple image display apparatus according to claim 1, wherein the back surface display apparatus has a liquid crystal display device and a backlight which illuminates the liquid crystal display device.

9. The multiple image display apparatus according to claim 1, wherein the back surface display apparatus includes a meter and a light source which illuminates the meter.

10. The multiple image display apparatus according to claim 1, wherein the back surface display apparatus has a cylindrical support member arranged to be rotatable and having images formed on an outer peripheral surface thereof, and a light source which illuminates the outer peripheral surface of the support member.
